(19) United States
(12) Patent Application Publication
(10) Pub. No.: US 2022/0180198 A1
(43) Pub. Date: Jun. 9, 2022

(54) TRAINING METHOD, STORAGE MEDIUM, AND TRAINING DEVICE

(71) Applicant: FUJITSU LIMITED, Kawasaki-shi (JP)

(72) Inventors: Akiba Miura, Setagaya (JP); Tomoya Iwakura, Kawasaki (JP)

(73) Assignee: FUJITSU LIMITED, Kawasaki-shi (JP)

(21) Appl. No.: 17/679,227

(22) Filed: Feb. 24, 2022

Related U.S. Application Data
(63) Continuation of application No. PCT/JP2019/034305, filed on Aug. 30, 2019.

(51) Int. Cl. G06N 3/08; G06N 3/04; G06F 40/166; G06F 40/117; G06F 40/20

(52) U.S. Cl. CPC G06N 3/08; G06N 3/04; G06F 40/20; G06F 40/117; G06F 40/166

(57) ABSTRACT

A training method for a computer to execute a process includes acquiring a model that includes an input layer and an intermediate layer, in which the intermediate layer is coupled to a first output layer and a second output layer; training the first output layer, the intermediate layer, and the input layer based on an output result from the first output layer when first training data is input into the input layer; and training the second output layer, the intermediate layer, and the input layer based on an output result from the second output layer when second training data is input into the input layer.

### CROSS-REFERENCE TO RELATED APPLICATION

This application is a continuation application of International Application PCT/JP2019/034305 filed on Aug. 30, 2019 and designated the U.S., the entire contents of which are incorporated herein by reference.

### FIELD

The embodiments discussed herein are related to a training method, a storage medium, and a training device.

### BACKGROUND

In recent years, in many fields such as language processing, a method of collectively training a plurality of models using a neural network has been used as a method of efficiently training a multi-layer neural network. For example, there is known a method of executing pre-training to train various parameters including a weight of a multi-layer neural network by unsupervised training, and thereafter, executing fine tuning to re-train, by using the pre-trained parameters as initial values, various parameters by supervised training using different training data.

For example, in the pre-training, a pre-trained model for performing word prediction is trained by unsupervised training using text data in a scale of hundreds of millions of sentences with some words hidden. Subsequently, in the fine tuning, the trained pre-trained model is combined with a model for predicting a named entity tag (beginning-inside-outside (BIO) tag) such as a name or a model for predicting a relation extraction label that indicates a relation between elements such as documents and words, and training is performed by using training data corresponding to each training model.

Japanese Laid-open Patent Publication No. 2019-016239 is disclosed as related art.

### SUMMARY

According to an aspect of the embodiments, a training method for a computer to execute a process includes acquiring a model that includes an input layer and an intermediate layer, in which the intermediate layer is coupled to a first output layer and a second output layer; training the first output layer, the intermediate layer, and the input layer based on an output result from the first output layer when first training data is input into the input layer; and training the second output layer, the intermediate layer, and the input layer based on an output result from the second output layer when second training data is input into the input layer.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing multi-task learning by a training device according to a first embodiment;

FIG. 2 is a diagram for describing prediction by the training device according to the first embodiment;

FIG. 3 is a functional block diagram illustrating a functional configuration of the training device according to the first embodiment;

FIG. 4 is a diagram illustrating an example of information stored in a training data database (DB);

FIG. 5 is a diagram illustrating an example of information stored in a prediction data DB;

FIG. 6 is a diagram for describing an example of a neural network of an entire multi-task learning model;

FIG. 7 is a diagram for describing an example of a neural network of a pre-trained model;

FIG. 8 is a diagram for describing a data flow of the pre-trained model;

FIG. 9 is a diagram for describing an example of a neural network of a named entity extraction model;

FIG. 10 is a diagram for describing a data flow of the named entity extraction model;

FIG. 11 is a flowchart illustrating a flow of training processing according to the first embodiment;

FIG. 12 is a flowchart illustrating a flow of prediction processing according to the first embodiment;

FIG. 13 is a diagram for describing multi-task learning by a training device according to a second embodiment;

FIG. 14 is a functional block diagram illustrating a functional configuration of the training device according to the second embodiment;

FIG. 15 is a diagram for describing an example of a neural network of an entire multi-task learning model according to the second embodiment;

FIG. 16 is a diagram for describing an example of a neural network of a relation extraction model;

FIG. 17 is a diagram for describing a data flow of the relation extraction model;

FIG. 18A and FIG. 18B are flowcharts illustrating a flow of training processing according to the second embodiment;

FIG. 19 is a diagram for describing multi-task learning by a training device according to a third embodiment;

FIG. 20 is a functional block diagram illustrating a functional configuration of the training device according to the third embodiment;

FIG. 21A and FIG. 21B are diagrams for describing an example of a neural network of adaptive training according to the third embodiment; and

FIG. 22 is a diagram illustrating an example of a hardware configuration.

### DESCRIPTION OF EMBODIMENTS

However, in the technology described above, in a case where a new model is connected to the trained pre-trained model generated by the pre-training and training is performed on the basis of text data and correct answer information by the fine tuning, characteristics of the trained pre-trained model are weakened, and prediction accuracy of an entire model decreases.

For example, the pre-trained model for performing word prediction trains contextual knowledge that affects prediction by repeating word prediction by the pre-training. However, in the fine tuning, the pre-trained model is re-trained by using training data having different characteristics from training data used in the pre-training. Thus, as characteristics, types, and the like of the training data are different between the pre-training and the fine tuning, the contextual knowledge trained by the pre-trained model in the pre-training is reduced, and it is not possible to sufficiently utilize a result of the pre-training.

In one aspect, an object is to provide a training method, a training program, and a training device that are capable of suppressing a decrease in accuracy of an entire model due to training.

Hereinafter, embodiments of a training method, a training program, and a training device according to the disclosed technology will be described in detail with reference to the drawings. Note that the embodiments do not limit the disclosed technology. Furthermore, each of the embodiments may be appropriately combined within a range without inconsistency.

### First Embodiment

### Description of Learning Device

A training device 10 according to a first embodiment executes multi-task learning in which pre-training (pre-training) and each training model (fine tuning) that trains each objective task are trained at the same time. By training the objective task at the same time in this way, information conforming to the objective task may be included in a pre-trained model from unlabeled data, and it is possible to suppress a decrease in prediction accuracy due to the fine tuning. Note that, in the embodiments, all training steps before the training for the objective task is started are collectively referred to as the pre-training.

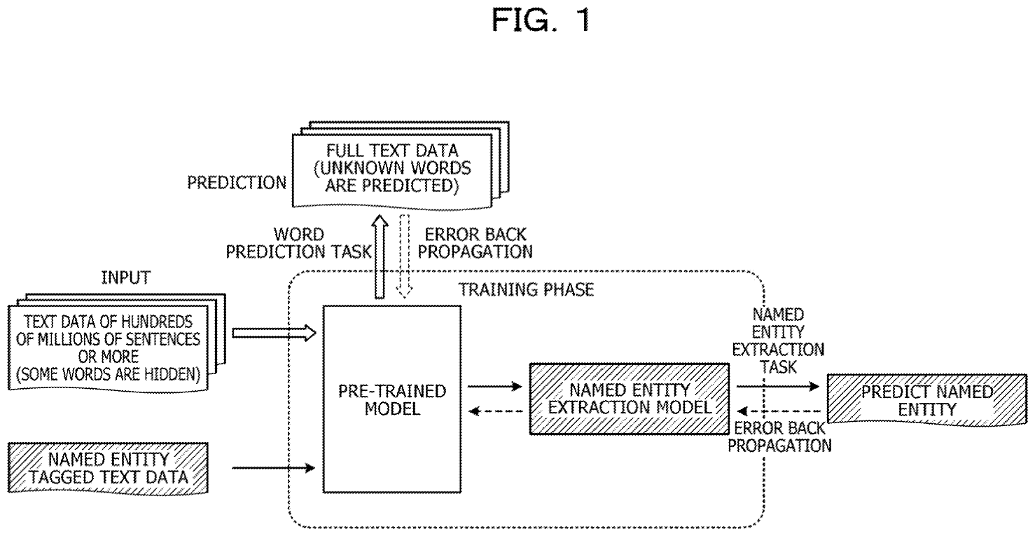

FIG. 1 is a diagram for describing the multi-task learning by the training device 10 according to the first embodiment. As illustrated in FIG. 1, the training device 10 trains a multi-task learning model (hereinafter may be simply referred to as a training model) that combines a pre-trained model trained in the pre-training and a named entity extraction model trained in the fine tuning. The multi-task learning model implements training of each model by sharing an input layer and an intermediate layer between the pre-trained model and the named entity extraction model, and switching an output layer. For example, the pre-trained model includes an input layer, an intermediate layer, and a first output layer, and the named entity extraction model includes the input layer, the intermediate layer, and a second output layer.

Such a training device 10 implements the multi-task learning by using a word prediction task for training the pre-trained model and a named entity extraction task for training the named entity extraction model.

The pre-trained model is a training model for training so as to predict an unknown word by using text data as an input. For example, the training device 10 trains the pre-trained model by unsupervised training using text data of hundreds of millions of sentences or more, which is training data. For example, the training device 10 inputs text data in which some words are masked into the input layer of the pre-trained model, and acquires, from the first output layer, text data in which unknown words are predicted and incorporated. Then, the training device 10 trains the pre-trained model having the first output layer, the intermediate layer, and the input layer by error back propagation using errors between the input text data and the output (predicted) text data.

The named entity extraction model is a training model in which the input layer and the intermediate layer of the pre-trained model are shared and the output layer (second output layer) is different in the multi-task learning model. The named entity extraction model is trained by supervised training using training data to which a named entity tag (beginning-inside-outside (BIO) tag) is attached. For example, the training device 10 inputs, into the input layer of the pre-trained model, text data to which a named entity tag is attached, and acquires, from the second output layer, an extraction result (prediction result) of the named entity tag. Then, the training device 10 trains the named entity extraction model having the second output layer, the intermediate layer, and the input layer by error back propagation such that an error between the label (named entity tag), which is correct answer information of the training model, and the predicted named entity tag is reduced.

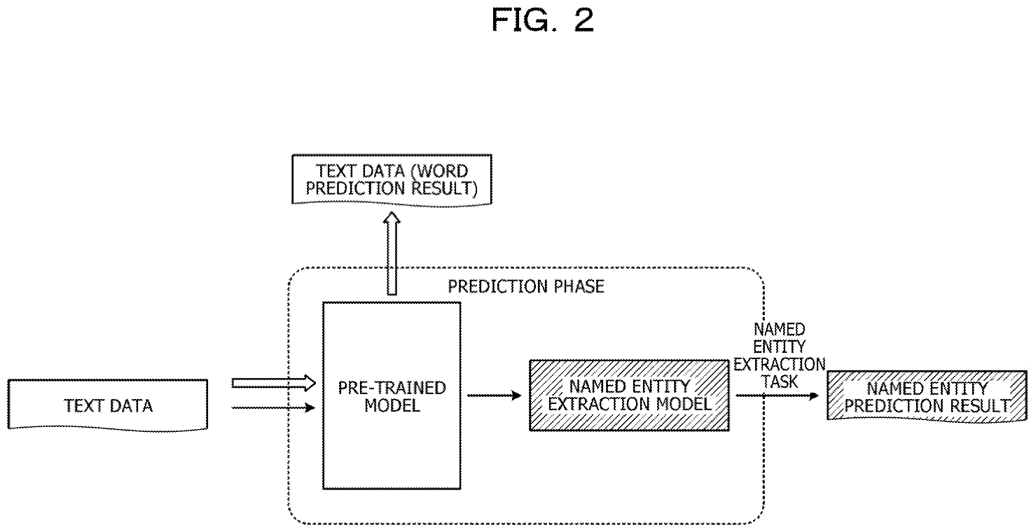

Furthermore, when the training of the multi-task learning model is completed, the training device 10 executes unknown word prediction or named entity prediction by using the trained multi-task learning model. FIG. 2 is a diagram for describing prediction by the training device 10 according to the first embodiment.

As illustrated in FIG. 2, in the case of prediction data for word prediction, the training device 10 inputs the prediction data into the pre-trained model, and acquires a prediction result. For example, the training device 10 inputs text data to be predicted into the input layer, and acquires an output result from the first output layer. Then, the training device 10 executes word prediction on the basis of the output result from the first output layer.

Furthermore, in the case of prediction data for named entity prediction, the training device 10 inputs the prediction data into the named entity extraction model, and acquires a prediction result. For example, the training device 10 inputs text data to be predicted into the input layer, and acquires an output result from the second output layer. Then, the training device 10 extracts a named entity on the basis of the output result from the second output layer.

### Functional Configuration

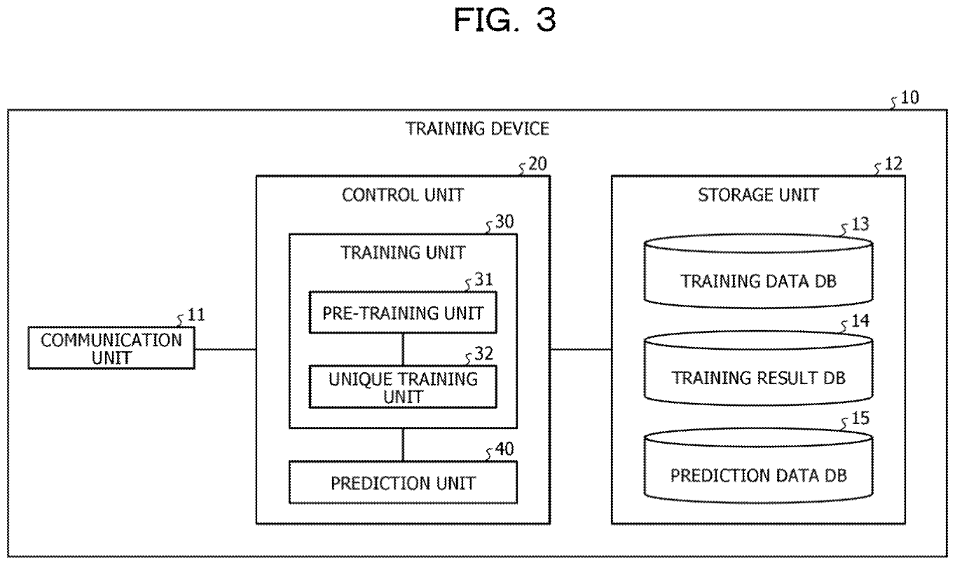

FIG. 3 is a functional block diagram illustrating a functional configuration of the training device 10 according to the first embodiment. As illustrated in FIG. 3, the training device 10 includes a communication unit 11, a storage unit 12, and a control unit 20.

The communication unit 11 is a processing unit that controls communication with another device, and is, for example, a communication interface. For example, the communication unit 11 receives instructions for starting various types of processing from a terminal used by an administrator, and transmits various processing results to the terminal used by the administrator.

The storage unit 12 is an example of a storage device that stores data and a program or the like executed by the control unit 20, and is, for example, a memory or a hard disk. The storage unit 12 stores a training data database (DB) 13, a training result DB 14, and a prediction data DB 15.

The training data DB 13 is a database that stores training data used to train the multi-task learning model. For example, the training data DB 13 stores training data for the pre-trained model and training data for the named entity extraction model of the multi-task learning model.

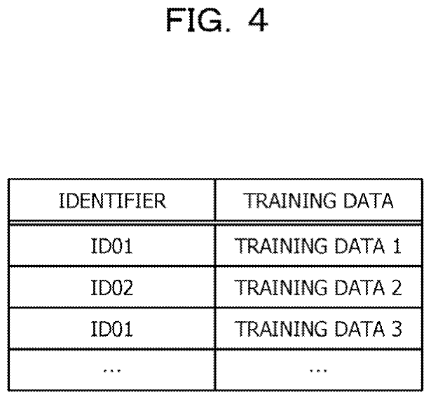

FIG. 4 is a diagram illustrating an example of information stored in the training data DB 13. As illustrated in FIG. 4, the training data DB 13 stores “identifier and training data”. The “identifier” is an identifier for distinguishing an objective model, and “ID01” is set in the training data for the pre-trained model, and “ID02” is set in the training data for the named entity extraction model. The “training data” is text data used for training. In the example of FIG. 4, training data 1 and training data 3 are the training data for the pre-trained model, and training data 2 is the training data for the named entity extraction model.

The training result DB 14 is a database that stores a training result of the multi-task learning model. For example, the training result DB 14 stores various parameters included in the pre-trained model and various parameters included in the named entity extraction model. Note that the training result DB 14 may also store the trained multi-task learning model itself.

The prediction data DB 15 is a database that stores prediction data used for prediction using the trained multi-task learning model. For example, the prediction data DB 15 stores prediction data to be input into the pre-trained model and prediction data to be input into the named entity extraction model of the multi-task learning model, similarly to the training data DB 13.

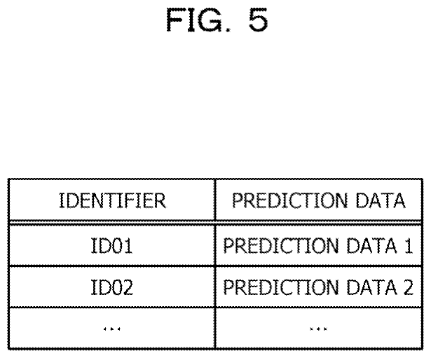

FIG. 5 is a diagram illustrating an example of information stored in the prediction data DB 15. As illustrated in FIG. 5, the prediction data DB 15 stores “identifier and prediction data”. The “identifier” is similar to that of the training data DB 13, and “ID01” is set in the prediction data for performing word prediction, and “ID02” is set in the prediction data for extracting a named entity. The “prediction data” is text data to be predicted. In the example of FIG. 5, prediction data 1 is input into the pre-trained model, and prediction data 2 is input into the named entity extraction model.

The control unit 20 is a processing unit that controls the entire training device 10, and is, for example, a processor. The control unit 20 includes a training unit 30 and a prediction unit 40. Note that the training unit 30 and the prediction unit 40 are examples of an electronic circuit included in a processor, examples of a process executed by a processor, or the like.

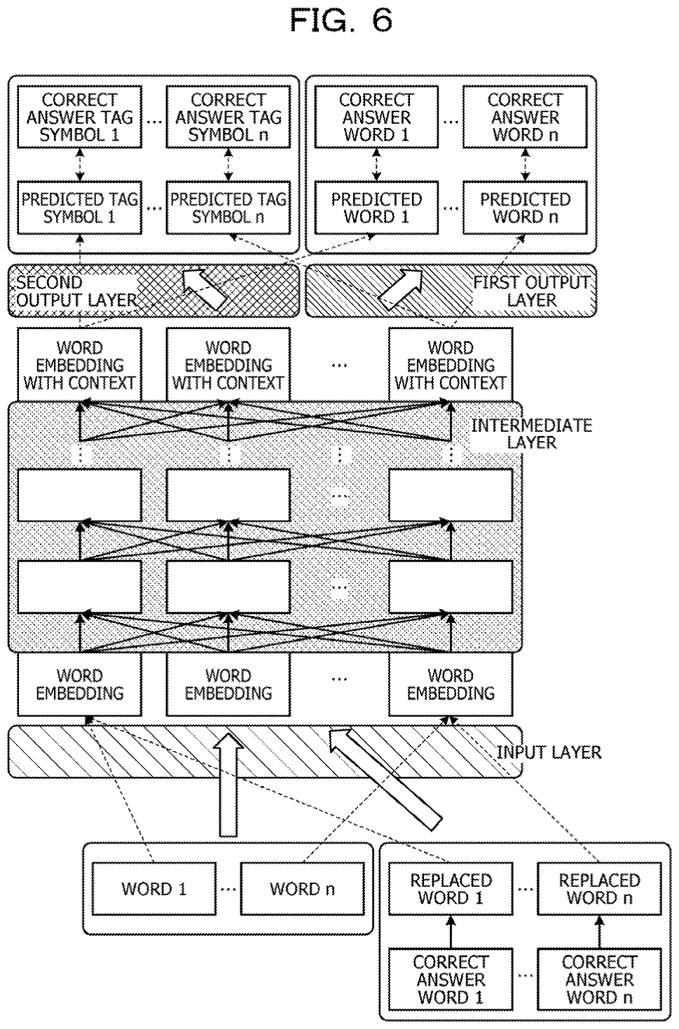

The training unit 30 is a processing unit that includes a pre-training unit 31 and a unique training unit 32, and executes training of the multi-task learning model. For example, the training unit 30 reads the multi-task learning model from the storage unit 12 or acquires the multi-task learning model from an administrator terminal or the like. Here, a multi-task learning model using a neural network will be described. FIG. 6 is a diagram for describing an example of a neural network of the entire multi-task learning model.

As illustrated in FIG. 6, the multi-task learning model executes training of a plurality of models at the same time by sharing the input layer and the intermediate layer by each model, and switching the output layer according to prediction contents. The input layer uses a word string and a symbol string for the same input. The intermediate layer updates various parameters such as a weight by a self-attention mechanism. The output layer has the first output layer and the second output layer, which are switched according to a task. Here, the pre-trained model is a model including the input layer, the intermediate layer, and the first output layer. The named entity extraction model is a model that uses the input layer and the intermediate layer of the pre-trained model, and includes these layers and the second output layer.

Such a training unit 30 reads training data from the training data DB 13, and trains the pre-trained model in a case where the identifier of the training data is “ID01”, and trains the named entity extraction model in a case where the identifier of the training data is “ID02”.

(Learning of Pre-Trained Model)

The pre-training unit 31 is a processing unit that trains the pre-trained model of the multi-task learning model. For example, the pre-training unit 31 inputs training data into the input layer, and trains the pre-trained model by unsupervised training based on an output result of the first output layer.

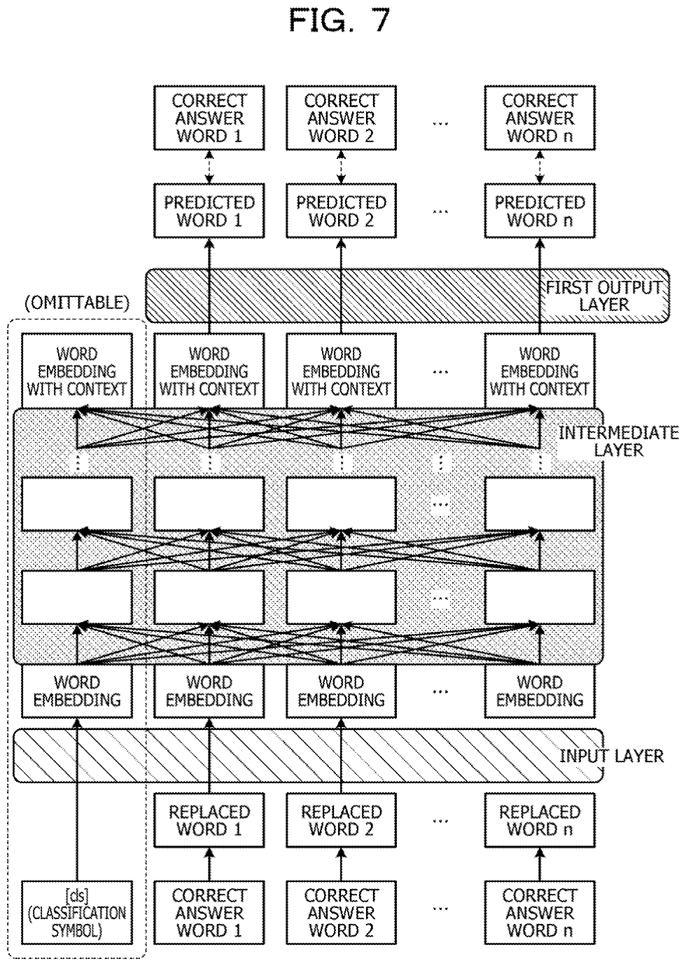

FIG. 7 is a diagram for describing an example of a neural network of the pre-trained model. As illustrated in FIG. 7, the pre-trained model is a language model of an autoencoder that removes noise. Into the input layer of the pre-trained model, data (replaced words 1 to n) in which words (correct answer words 1 to n) in text data which is training data are replaced with other words with a certain probability are input. For example, the pre-training unit 31 generates text data in which words are not changed at 88% probability, words are replaced with mask symbols ([mask]) at 9% probability, and words are replaced with different words at 3% probability. Then, the pre-training unit 31 divides the text data into each word and inputs each word into the input layer.

Subsequently, in the input layer, word embedding and the like are executed, and an integer value (word identification (ID)) corresponding to each word is converted into a fixed-dimensional vector (for example, 1024 dimensions). Here, a word embedding is generated and input into the intermediate layer. In the intermediate layer, processing of executing self-attention, calculating weights and the like for all pairs of input vectors, and adding the calculated weights and the like to an original embedding as context information is repeated a predetermined number of times (for example, 24 times). Here, a word embedding with a context, which corresponds to each word embedding, is input into the first output layer.

Thereafter, in the first output layer, word restoration prediction is executed, and predicted words 1 to n corresponding to the respective word embeddings with a context are output. Then, by comparing the predicted words 1 to n output from the first output layer with the correct answer words 1 to n corresponding to the respective predicted words, each parameter of the neural network is adjusted by error back propagation so that a prediction result becomes close to a correct answer word.

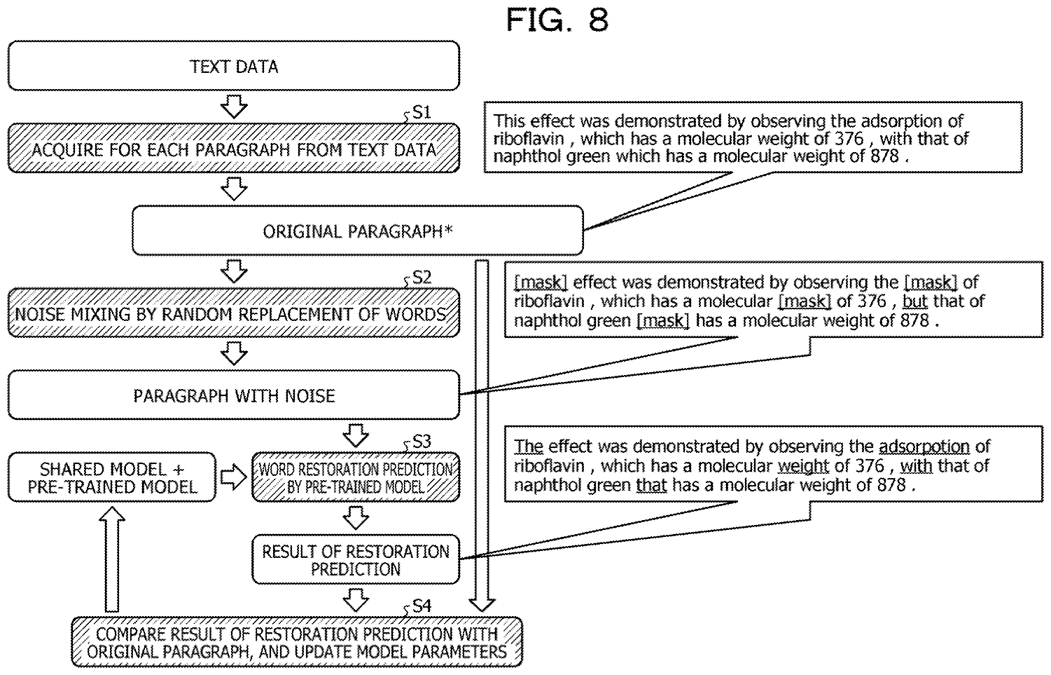

Next, a training example of the pre-trained model will be described by using a specific example. FIG. 8 is a diagram for describing a data flow of the pre-trained model. As illustrated in FIG. 8, the pre-training unit 31 acquires text data which is training data, and acquires data (paragraph text) for each paragraph from the text data (S1).

For example, the pre-training unit 31 acquires a paragraph text

“This effect was demonstrated by observing the adsorption of riboflavin, which has a molecular weight of 376, with that of naphthol green which has a molecular weight of 878.”.

Subsequently, the pre-training unit 31 performs noise mixing by random replacement of words on the original data (original paragraph) to generate paragraph text with noise, which is text data with noise (S2).

For example, as illustrated in FIG. 8, the pre-training unit 31 replaces [This] with [mask] or intentionally replace “with” with wrong “but” to generate the paragraph text with noise. In this way, the pre-training unit 31 generates the paragraph text with noise “[mask] effect was demonstrated by observing the [mask] of riboflavin, which has a molecular [mask] of 376, (but) that of naphthol green [mask] has a molecular weight of 878.”. Note that parentheses and the like are used to distinguish from the correct answer paragraph text, for the purpose of description.

Then, the pre-training unit 31 divides the paragraph text with noise into words, inputs the words into the pre-trained model for performing word prediction, and acquires a result of word restoration prediction from the first output layer (S3). For example, the pre-training unit 31 acquires a result of restoration prediction “[The] effect was demonstrated by observing the [adsorpotion] of riboflavin, which has a molecular [weight] of 376, (with) that of naphthol green [that] has a molecular weight of 878.”. Thereafter, the pre-training unit 31 compares the result of the restoration prediction with the original paragraph, and updates parameters of the pre-trained model including the shared model (input layer and intermediate layer) (S4).

In this way, the pre-training unit 31 generates a paragraph text with noise for each paragraph of the text data. Then, the pre-training unit 31 executes training so that an error between a result of restoration prediction using each paragraph text with noise and an original paragraph text is reduced. Note that an input unit of one step may be optionally set to “sentence”, “paragraph”, “document (entire document)”, or the like, and is not limited to handling in a paragraph unit.

(Learning of Named Entity Extraction Model)

The unique training unit 32 is a processing unit that trains the named entity extraction model of the multi-task learning model. For example, the unique training unit 32 inputs training data into the input layer, and trains the named entity extraction model by supervised training based on an output result of the second output layer.

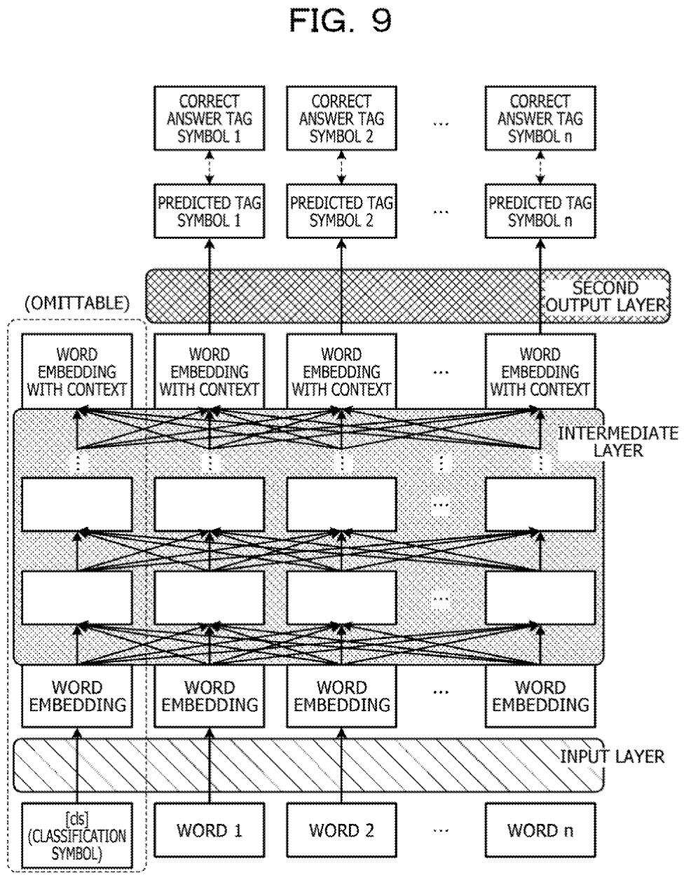

FIG. 9 is a diagram for describing an example of a neural network of the named entity extraction model. As illustrated in FIG. 9, the input layer and the intermediate layer of the named entity extraction model are shared with the pre-trained model. Into the input layer, each word of text data (sentence) is input as it is.

Subsequently, as in the pre-trained model, in the input layer, word embedding and the like are executed, an integer value (word ID) corresponding to each word is converted into a fixed-dimensional vector, and a word embedding is generated and input into the intermediate layer. In the intermediate layer, processing of executing self-attention, calculating weights and the like for all pairs of input vectors, and adding the calculated weights and the like to an original embedding as context information is repeated a predetermined number of times. Here, a word embedding with a context, which corresponds to each word embedding, is input into the first output layer.

Thereafter, in the second output layer, prediction of a named entity tag is executed, and predicted tag symbols 1 to n corresponding to the respective word embeddings with a context are output. Then, by comparing the predicted tag symbols 1 to n output from the second output layer with correct answer tag symbols 1 to n corresponding to the respective predicted tag symbols 1 to n, each parameter of the neural network is adjusted by error back propagation so that a prediction result becomes close to a correct answer tag symbol.

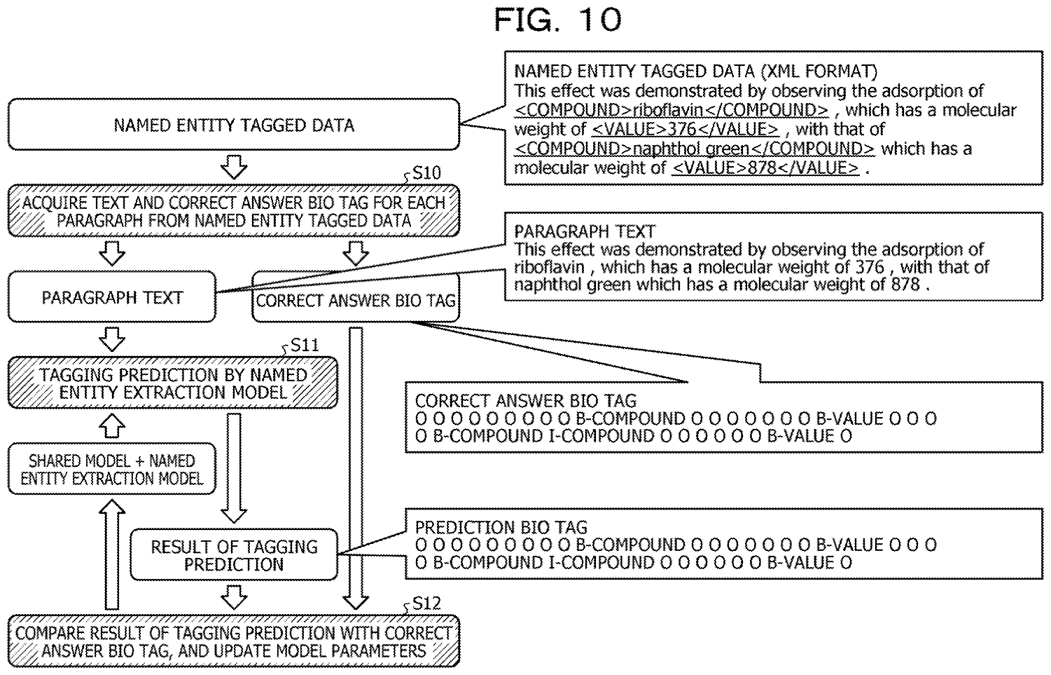

Next, a training example of the named entity extraction model will be described by using a specific example. FIG. 10 is a diagram for describing a data flow of the named entity extraction model. As illustrated in FIG. 10, the unique training unit 32 acquires named entity tagged data in an extensible markup language (XML) format, which is training data, and acquires text data and a correct answer BIO tag for each paragraph from the named entity tagged data (S10).

For example, the unique training unit 32 acquires text data that includes named entity tags such as <COMPOUND>riboflavin</COMPOUND>, <VALUE>376</VALUE>, <COMPOUND>naphthol green</COMPOUND>, and <VALUE>878</VALUE>. Then, the unique training unit 32 generates a paragraph text “This effect was demonstrated by observing the adsorption of riboflavin, which has a molecular weight of 376, with that of naphthol green which has a molecular weight of 878.”, which is text data without these named entity tags. Moreover, the unique training unit 32 generates a correct answer BIO tag “O O O O O O O O O B-COMPOUND O O O O O O O B-VALUE O O O O B-COMPOUND I-COMPOUND O O O O O O B-VALUE O”, which serves as correct answer information (label) for supervised training. Note that, corresponding to the respective words of the input, meanings are “B-*: start of named entity”, “I-*: inside of named entity”, and “O: Other (not named entity)”. Here, * is a named entity category. Since there is a one-to-one correspondence between an XML tag and a BIO tag, it is possible to predict a BIO tag at the time of prediction, and then convert the BIO tag into a tagged sentence in combination with an input.

Thereafter, the unique training unit 32 inputs the paragraph text, which is text data without the named entity tags, into the named entity extraction model, and executes tagging prediction by the named entity extraction model (S11). Then, the unique training unit 32 acquires a result of the tagging prediction from the second output layer, compares the result of the tagging prediction “O O O O O O O O O B-COMPOUND O O O O O O O B-VALUE O O O O B-COMPOUND I-COMPOUND O O O O O O B-VALUE O” with the correct answer BIO tag described above, and updates parameters of the named entity extraction model including the shared model (input layer and intermediate layer) (S12).

Returning to FIG. 3, the prediction unit 40 is a processing unit that executes word prediction or extraction of a named entity tag by using the trained multi-task learning model. For example, the prediction unit 40 reads prediction data to be predicted from the prediction data DB 15, and executes prediction using the pre-trained model in a case where the identifier is “ID01”, and executes prediction using the named entity extraction model in a case where the identifier is “ID02”.

For example, in the case of prediction data whose identifier is “ID01”, the prediction unit 40 divides text data which is the prediction data into words, inputs the words into the input layer of the multi-task learning model, and acquires an output result from the first output layer. Then, the prediction unit 40 acquires, as a prediction result, a word with the highest probability among probabilities (likelihoods) of prediction results of words corresponding to the input words obtained from the first output layer.

Furthermore, in the case of prediction data whose identifier is “ID02”, the prediction unit 40 divides text data which is the prediction data into words, inputs the words into the input layer of the multi-task learning model, and acquires an output result from the second output layer. Then, the prediction unit 40 restores named entity tagged data by using a BIO tag and the prediction data obtained from the second output layer.

### Flow of Learning Processing

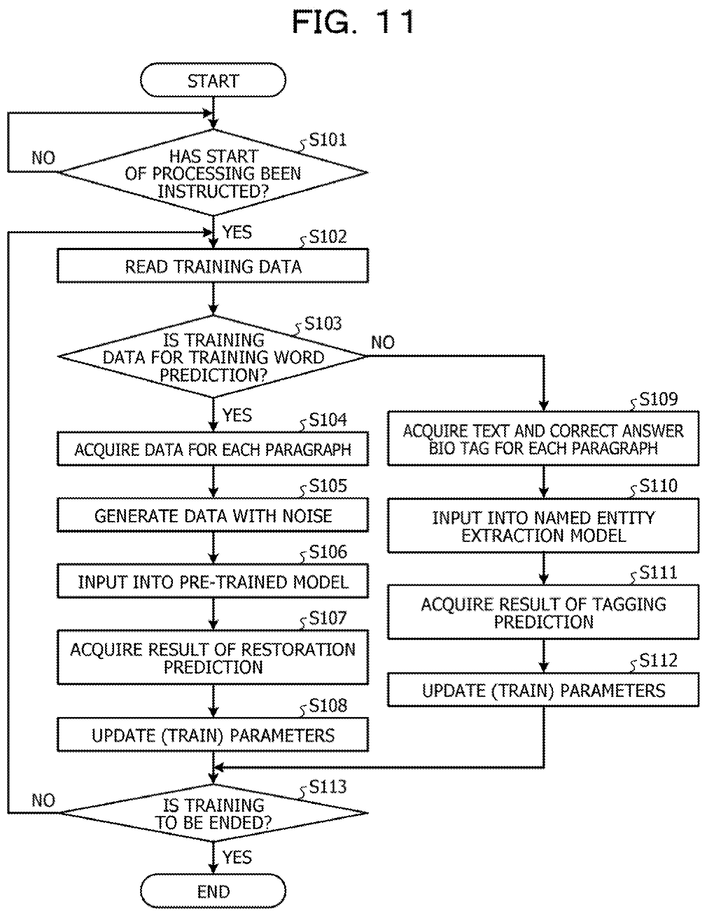

FIG. 11 is a flowchart illustrating a flow of training processing according to the first embodiment. As illustrated in FIG. 11, when the training unit 30 is instructed to start the training processing (S101: Yes), the training unit 30 reads training data from the training data DB 13 (S102).

Subsequently, in the case of the training data for training word prediction (S103: Yes), the training unit 30 acquires data for each paragraph at a time (S104), and generates data with noise (S105). Then, the training unit 30 inputs the data with noise into the pre-trained model (S106), and acquires a result of restoration prediction from the first output layer (S107). Thereafter, the training unit 30 executes update of parameters of the pre-trained model on the basis of the result of the restoration prediction (S108).

On the other hand, in the case of the training data for extraction of a named entity (S103: No) instead of the training data for training word prediction, the training unit 30 acquires text data and a BIO tag for each paragraph (S109).

Subsequently, the training unit 30 inputs the text data into the named entity extraction model (S110), and acquires a result of tagging prediction from the second output layer (S111). Thereafter, the training unit 30 executes update of parameters of the named entity extraction model on the basis of the result of the tagging prediction (S112).

Thereafter, in a case where the training is to be continued (S113: No), the training unit 30 repeats the steps after S102, and in a case where the training is to be ended (S113: Yes), the training unit 30 stores a training result in the training result DB 14, and ends the training of the multi-task learning model.

### Flow of Prediction Processing

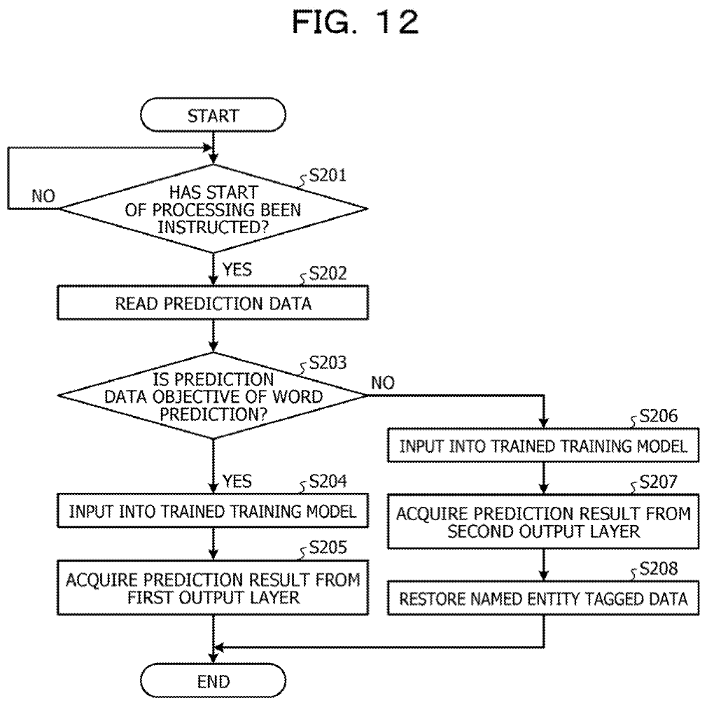

FIG. 12 is a flowchart illustrating a flow of prediction processing according to the first embodiment. As illustrated in FIG. 12, when the prediction unit 40 is instructed to start the prediction processing (S201: Yes), the prediction unit 40 reads prediction data from the prediction data DB 15 (S202).

Subsequently, in a case where the prediction data is an objective of word prediction (S203: Yes), the prediction unit 40 divides the prediction data into words, and inputs the words into the pre-trained model of the trained multi-task learning model (S204). Then, the prediction unit 40 acquires a prediction result from the first output layer, and executes word prediction on the basis of the prediction result (S205).

On the other hand, in a case where the prediction data is an objective of extraction of a named entity (S203: No), the prediction unit 40 divides the prediction data into words, and inputs the words into the named entity extraction model of the trained multi-task learning model (S206). Then, the prediction unit 40 acquires a prediction result from the second output layer (S207), and, on the basis of the prediction result, acquires a BIO prediction tag, and restores named entity tagged data (S208).

### Effects

According to the first embodiment, since the training device 10 may train each training model by switching the output layer according to a type of training data, pre-training and fine tuning may be executed at the same time. As a result, since the pre-trained model may continue training contextual knowledge even during the fine tuning while training contextual knowledge by the pre-training, the training device 10 may suppress a decrease in accuracy of the entire model due to the training.

Furthermore, even in a case where it is not possible to secure a sufficient number of pieces of training data for each model, the training device 10 may be expected to be able to utilize information obtained from unlabeled data and information obtained from a related task by training the related task at the same time as the pre-training, and the training device 10 may train characteristics such as a named entity and relation extraction at the same time. Furthermore, since the training device 10 may execute the pre-training and the fine tuning at the same time, a training time may be shortened as compared with a general method.

### Second Embodiment

Incidentally, in the first embodiment, an example of training two tasks at the same time has been described, but the embodiment is not limited to this example, and three or more tasks may be executed at the same time. Thus, in a second embodiment, as an example, an example will be described in which training of a relation extraction model for predicting a relation extraction label indicating a relation between elements such as documents and words is executed at the same time, in addition to the pre-trained model and the named entity extraction model.

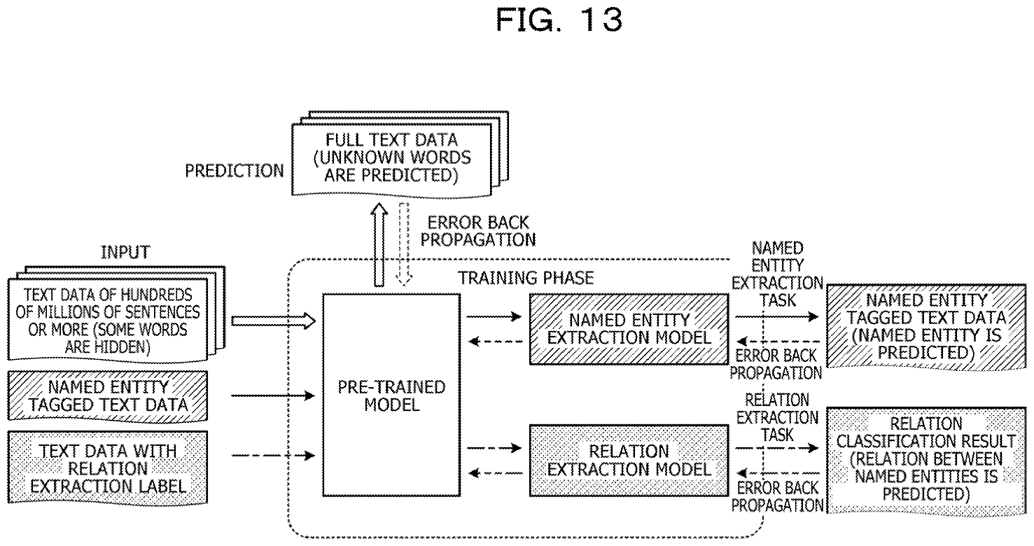

FIG. 13 is a diagram for describing multi-task learning by a training device 10 according to the second embodiment. As illustrated in FIG. 13, the training device 10 according to the second embodiment trains a multi-task learning model including the relation extraction model, in addition to the pre-trained model and the named entity extraction model. The multi-task learning model implements training of each model by sharing an input layer and an intermediate layer between the pre-trained model, the named entity extraction model, and the relation extraction model, and switching an output layer. For example, the pre-trained model includes the input layer, the intermediate layer, and a first output layer, the named entity extraction model includes the input layer, the intermediate layer, and a second output layer, and the relation extraction model includes the input layer, the intermediate layer, and a third output layer.

Such a training device 10 implements the multi-task learning by using a word prediction task for training the pre-trained model, a named entity extraction task for training the named entity extraction model, and a relation extraction task for training the relation extraction model. Note that, since training of the pre-trained model and training of the named entity extraction model are similar to those in the first embodiment, detailed description thereof will be omitted.

The relation extraction model is a training model in which the input layer and the intermediate layer of the pre-trained model are shared and the output layer (third output layer) is different in the multi-task learning model. The relation extraction model is trained by supervised training using training data to which a relation label indicating a relation between named entities is attached.

For example, the training device 10 inputs, into the input layer of the pre-trained model, text data to which a relation label is attached, and acquires, from the third output layer, a prediction result of the relation label. Then, the training device 10 trains the relation extraction model having the third output layer, the intermediate layer, and the input layer by error back propagation such that an error between correct answer information of the training model and the prediction result is reduced.

### Functional Configuration

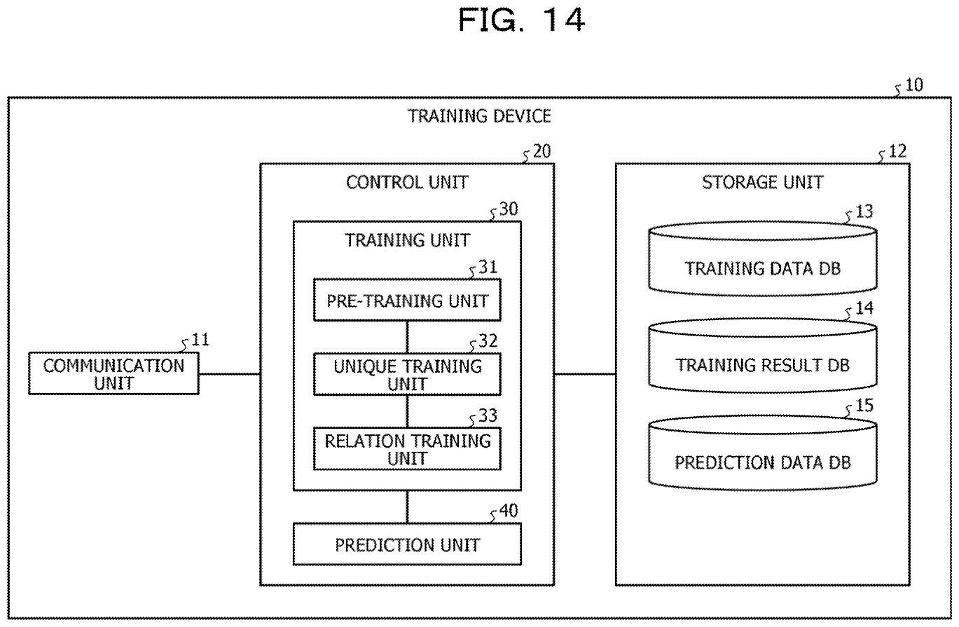

FIG. 14 is a functional block diagram illustrating a functional configuration of the training device 10 according to the second embodiment. As illustrated in FIG. 14, the training device 10 includes a communication unit 11, a storage unit 12, and a control unit 20. A difference from the first embodiment is that a relation training unit 33 is included. Note that a training data DB 13 and a prediction data DB 15 also store data to which an identifier “ID03” indicating training data for the relation extraction model is attached.

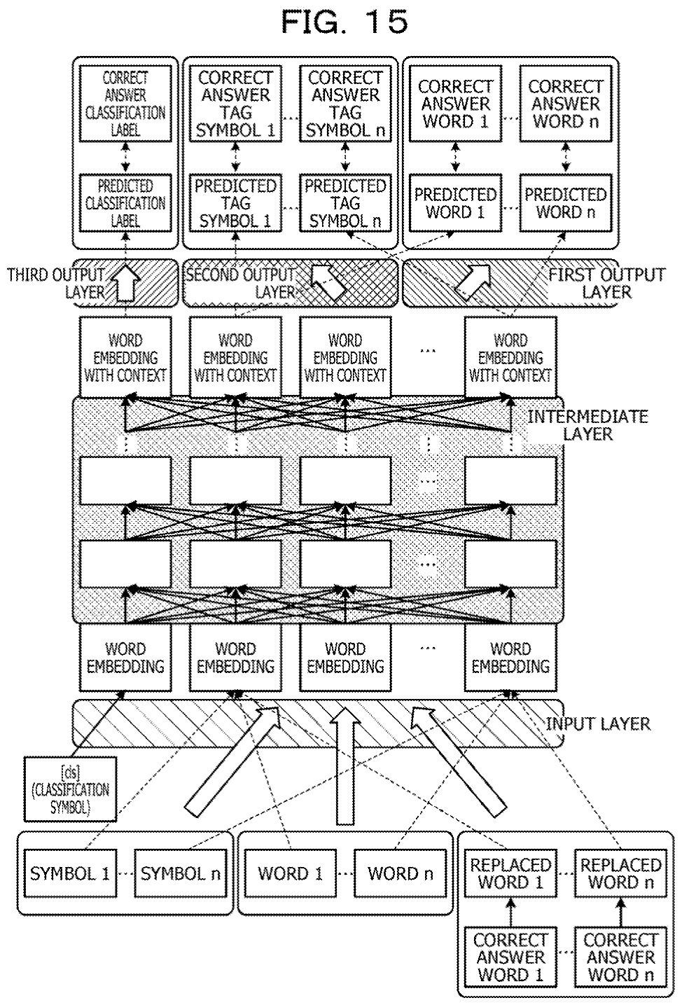

FIG. 15 is a diagram for describing an example of a neural network of the entire multi-task learning model according to the second embodiment. As illustrated in FIG. 15, as in the first embodiment, the multi-task learning model executes training of a plurality of models at the same time by sharing the input layer and the intermediate layer by each model, and switching the output layer according to prediction contents. The input layer uses a word string and a symbol string for the same input. The intermediate layer updates various parameters such as a weight by a self-attention mechanism. The output layer has the first output layer, the second output layer, and the third output layer, which are switched according to a task. Here, the pre-trained model is a model including the input layer, the intermediate layer, and the first output layer. The named entity extraction model is a model including the input layer and intermediate layer of the pre-trained model and the second output layer, and the relation extraction model is a model including the input layer and intermediate layer of the pre-trained model and the third output layer.

Such a training unit 30 reads training data from the training data DB 13, and trains the pre-trained model in a case where the identifier of the training data is “ID01”, trains the named entity extraction model in a case where the identifier of the training data is “ID02”, and trains the relation extraction model in a case where the identifier of the training data is “ID03”.

(Learning of Relation Extraction Model)

The relation training unit 33 is a processing unit that trains the relation extraction model of the multi-task learning model. For example, the relation training unit 33 inputs training data into the input layer, and trains the relation extraction model by supervised training based on an output result of the third output layer.

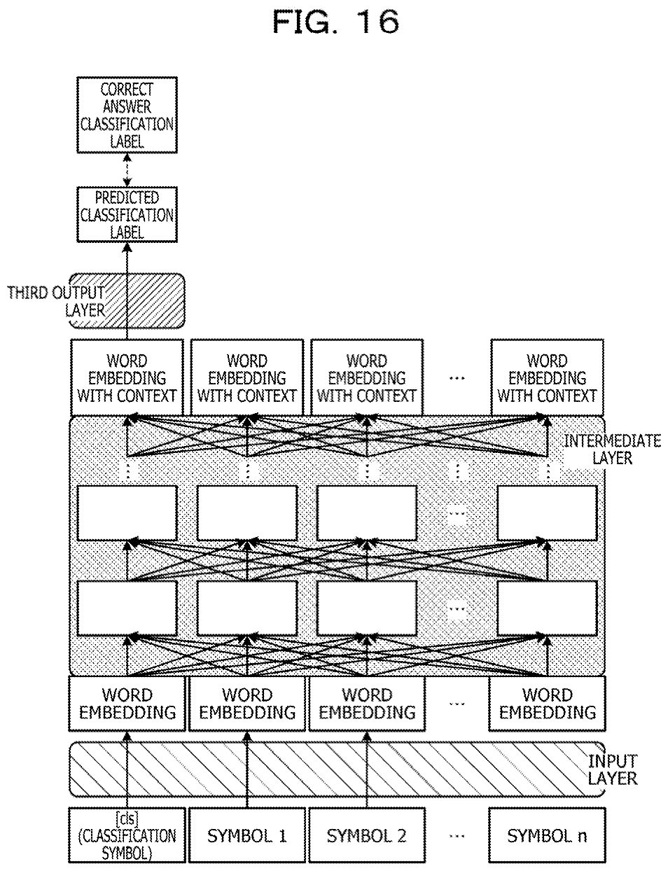

FIG. 16 is a diagram for describing an example of a neural network of the relation extraction model. As illustrated in FIG. 16, the input layer and the intermediate layer of the relation extraction model are shared with the pre-trained model. Into the input layer, a word and symbol string (tag information) of text data (sentence) to which a relation extraction label indicating a relation between named entities is added and a classification symbol are input.

Subsequently, as in the pre-trained model, in the input layer, word embedding and the like are executed, an integer value (word ID) corresponding to each word is converted into a fixed-dimensional vector, and a word embedding is generated and input into the intermediate layer. In the intermediate layer, processing of executing self-attention, calculating weights and the like for all pairs of input vectors, and adding the calculated weights and the like to an original embedding as context information is repeated a predetermined number of times. Here, a word embedding with a context, which corresponds to each word embedding, is generated, and the word embedding with a context, which corresponds to the classification symbol, is input into the third output layer.

Thereafter, in the third output layer, prediction of the relation extraction label indicating a relation between elements is executed, and a predicted classification label is output from the word embedding with a context. Then, by comparing the predicted classification label output from the third output layer with a correct answer label, each parameter of the neural network is adjusted by error back propagation so that a prediction result becomes close to the correct answer label.

For example, the training device 10 acquires, as the prediction result, probabilities (likelihoods or probability scores) corresponding to a plurality of labels assumed in advance. Then, the training device 10 executes training by error back propagation so that a probability of the correct answer label is the highest among the plurality of labels assumed in advance.

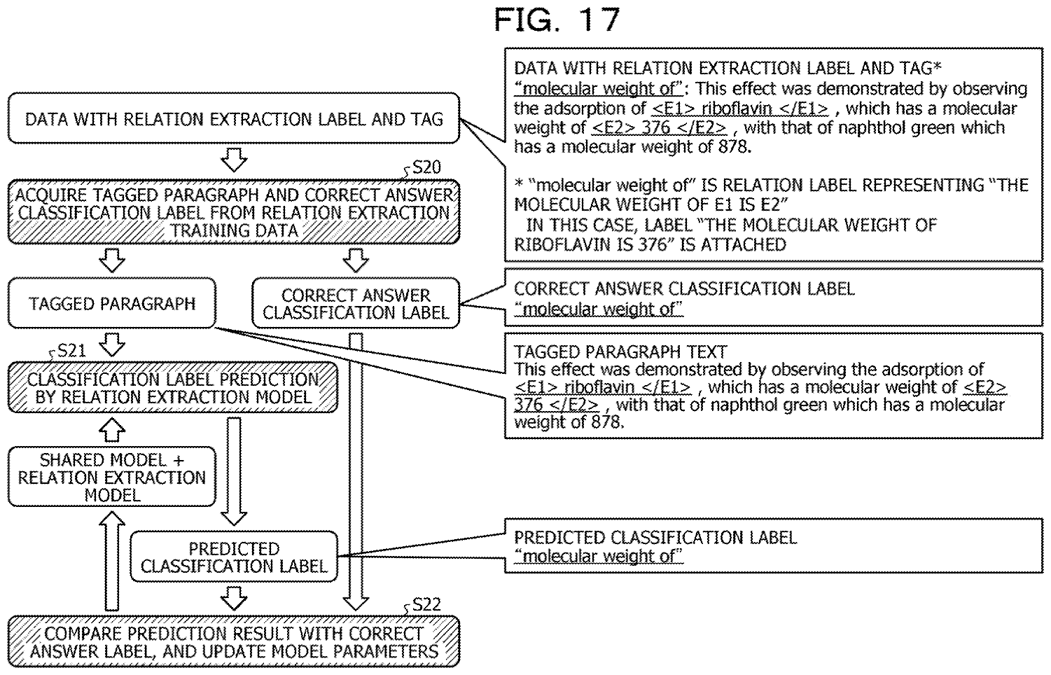

Next, a training example of the relation extraction model will be described by using a specific example. FIG. 17 is a diagram for describing a data flow of the relation extraction model. As illustrated in FIG. 17, the relation training unit 33 acquires, as training data, tagged data and a correct answer classification label for each paragraph from text data to which a relation extraction label which is correct answer information and a tag that specifies an element for which a relation is specified by the relation extraction label are attached (S20).

For example, the relation training unit 33 acquires training data to which a relation extraction label “molecular weight of” is attached and tags “<E1></E1>” and “<E2></E2>” are set. For example, the relation training unit 33 acquires training data ““molecular weight of”: This effect was demonstrated by observing the adsorption of <E1>riboflavin </E1>, which has a molecular weight of <E2>376</E2>, with that of naphthol green which has a molecular weight of 878.”. Here, “molecular weight of” is a relation label representing “the molecular weight of E1 is E2”, and in the case of FIG. 17, a label “the molecular weight of riboflavin is 376” is attached. Then, the relation training unit 33 acquires a tagged paragraph text “This effect was demonstrated by observing the adsorption of <E1>riboflavin</E1>, which has a molecular weight of <E2>376</E2>, with that of naphthol green which has a molecular weight of 878.” and the correct answer classification label ““molecular weight or””.

Thereafter, the relation training unit 33 inputs the tagged paragraph text into the relation extraction model, and executes classification label prediction by the relation extraction model (S21). Then, the relation training unit 33 acquires a result of the classification label prediction from the third output layer, compares the predicted classification label ““molecular weight or”” with the correct answer classification label ““molecular weight or””, and updates parameters of the relation extraction model including the shared model (input layer and intermediate layer) (S22).

### Flow of Learning Processing

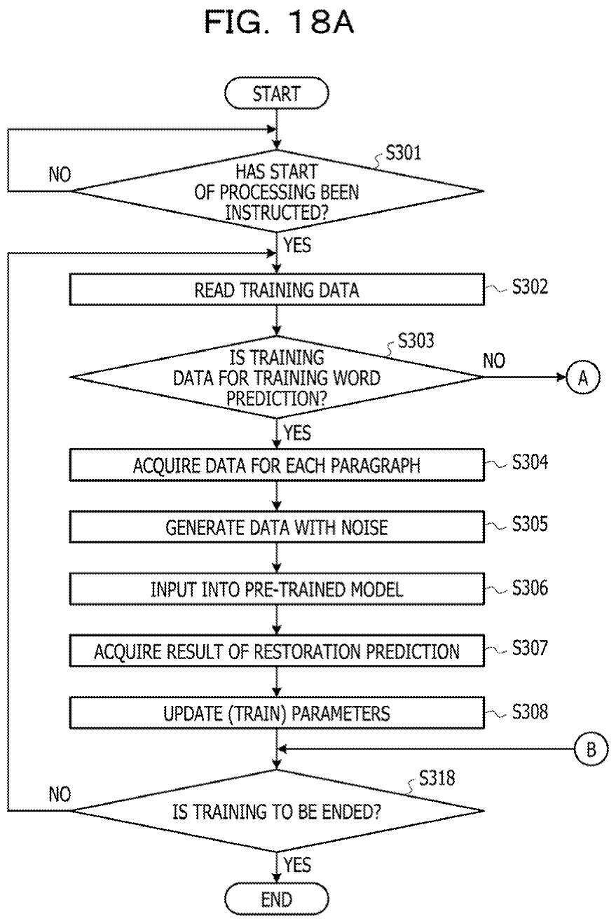

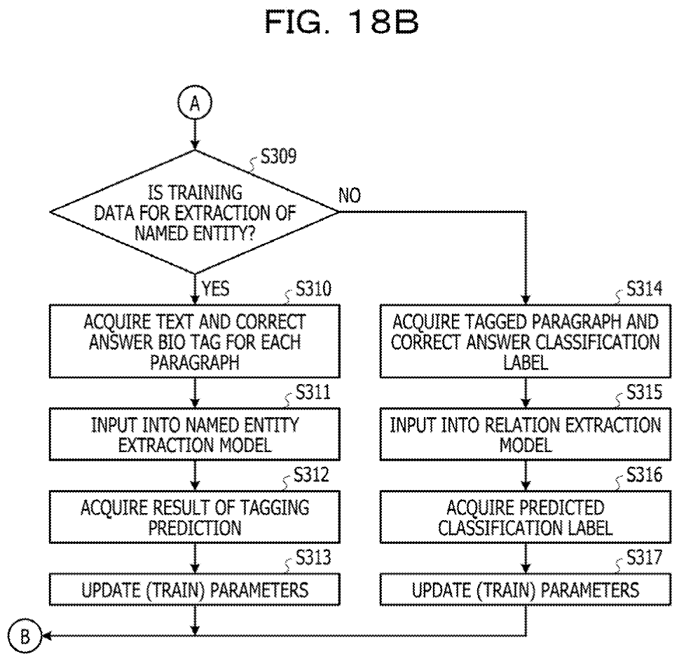

FIG. 18A and FIG. 18B are flowcharts illustrating a flow of training processing according to the second embodiment. As illustrated in FIG. 11, processing from S301 to S308 is similar to the processing from S101 to S108 of FIG. 11. Thus, the detailed description will be omitted. Furthermore, processing from S309: Yes to S313 is similar to the processing from S109 to S112 of FIG. 11. Thus, the detailed description will be omitted. Here, S309: No and subsequent steps, which are different from those of FIG. 11, will be described.

For example, in the case of training data for extracting a relation (S309: No), the training unit 30 acquires a tagged paragraph and a correct answer classification label from the training data (S314). Subsequently, the training unit 30 inputs the tagged paragraph into the relation extraction model (S315), and acquires a predicted classification label (S316). Then, the training unit 30 executes update of parameters of the predicted classification label on the basis of a result of restoration prediction (S317).

Thereafter, in a case where the training is to be continued (S318: No), the training unit 30 repeats the steps after S302, and in a case where the training is to be ended (S318: Yes), the training unit 30 stores a training result in the training result DB 14, and ends the training of the multi-task learning model.

Note that, at the time of prediction, prediction processing using any of the pre-trained model, the named entity extraction model, and the relation extraction model is executed according to an identifier of prediction data.

### Effects

According to the second embodiment, since the training device 10 may train the pre-trained model, the named entity extraction model, and the relation extraction model at the same time, a training time may be shortened as compared with the case of training separately. Furthermore, since the training device 10 may train a feature amount of the training data used for each model, the training device 10 may train more contextual knowledge in language processing as compared with the case of training for each model, and training accuracy may be improved.

### Third Embodiment

Incidentally, by training another training model by using the trained multi-task learning model, it is possible to shorten a training time and improve training accuracy. For example, a training model corresponding to a task of a type similar to a type of a task used to train the multi-task learning model is executed by using the trained multi-task learning model. For example, in a case where the multi-task learning model is trained by a task related to biotechnology, the trained multi-task learning model is reused to train a training model related to chemistry, which is in a domain similar to a training model related to biotechnology and is similar to the training model related to biotechnology.

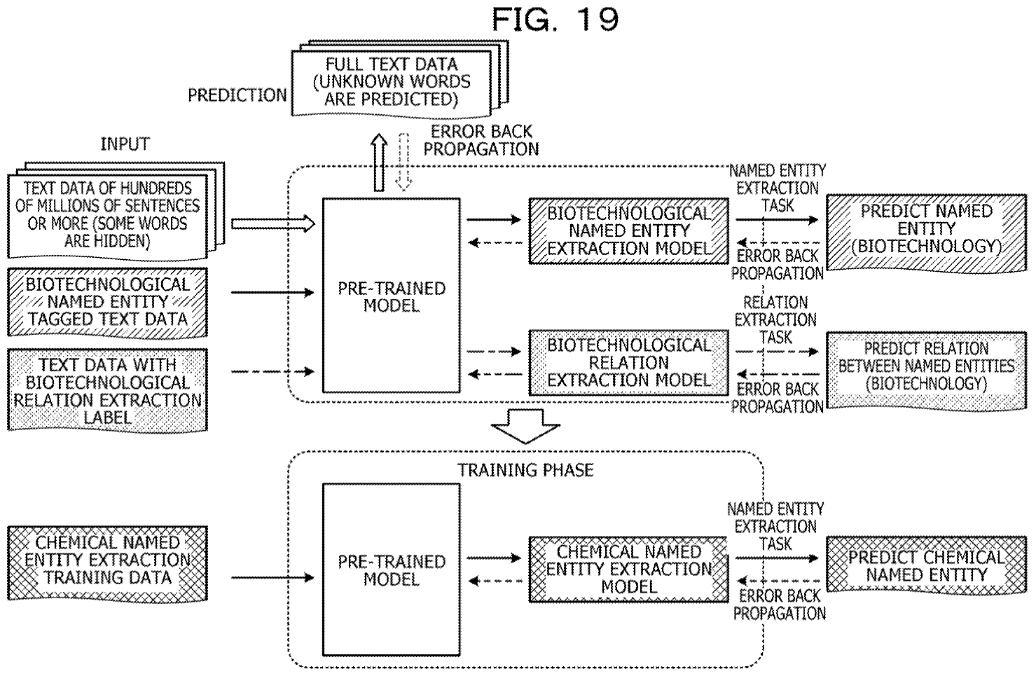

FIG. 19 is a diagram for describing multi-task learning by a training device 10 according to a third embodiment. As illustrated in FIG. 19, first, as in the second embodiment, the training device 10 executes a multi-task learning model including a pre-trained model for predicting a word related to biotechnology, a named entity extraction model for extracting a named entity in biotechnology, and a relation extraction model for extracting a relation in biotechnology.

Thereafter, the training device 10 removes the named entity extraction model and the relation extraction model from the multi-task learning model, and generates a new multi-task learning model incorporating a chemical named entity extraction model for extracting a named entity in chemistry. For example, the chemical named entity extraction model is a training model that uses an input layer and an intermediate layer of a trained pre-trained model.

Then, the training device 10 inputs training data for training the chemical named entity extraction model into the input layer, and trains parameters by error back propagation using a result of an output layer. Note that, since a data flow of the training data for training the chemical named entity extraction model is similar to that of FIG. 10, detailed description will be omitted.

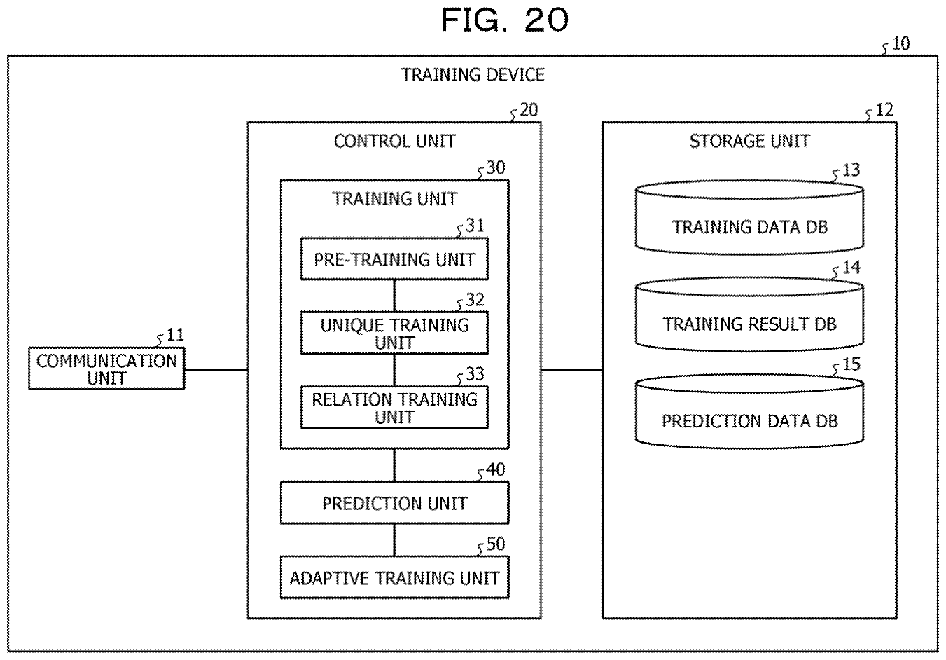

FIG. 20 is a functional block diagram illustrating a functional configuration of the training device 10 according to the third embodiment. As illustrated in FIG. 20, the training device 10 includes a communication unit 11, a storage unit 12, and a control unit 20. A difference from the second embodiment is that an adaptive training unit 50 is included. Note that a training data DB 13 and a prediction data DB 15 also store data to which an identifier “ID04” identifying the relation extraction model to be adapted is attached.

The adaptive training unit 50 is a processing unit that adapts the multi-task learning model trained by a training unit 30 to training of another training model. For example, the adaptive training unit 50 adapts the multi-task learning model executed by using a task similar to a task to be trained. Note that “similar” refers to tasks of biotechnology and chemistry, dynamics and quantum mechanics, or the like, which have an inclusive relation, a relation of a superordinate concept and a subordinate concept, or the like, and also applies to a case where common training data is included in training data, and the like.

In the third embodiment, the adaptive training unit 50 trains, by using a multi-task learning model trained by a task related to biotechnology, a chemical named entity extraction model for extracting a named entity in chemistry related to the trained biotechnology.

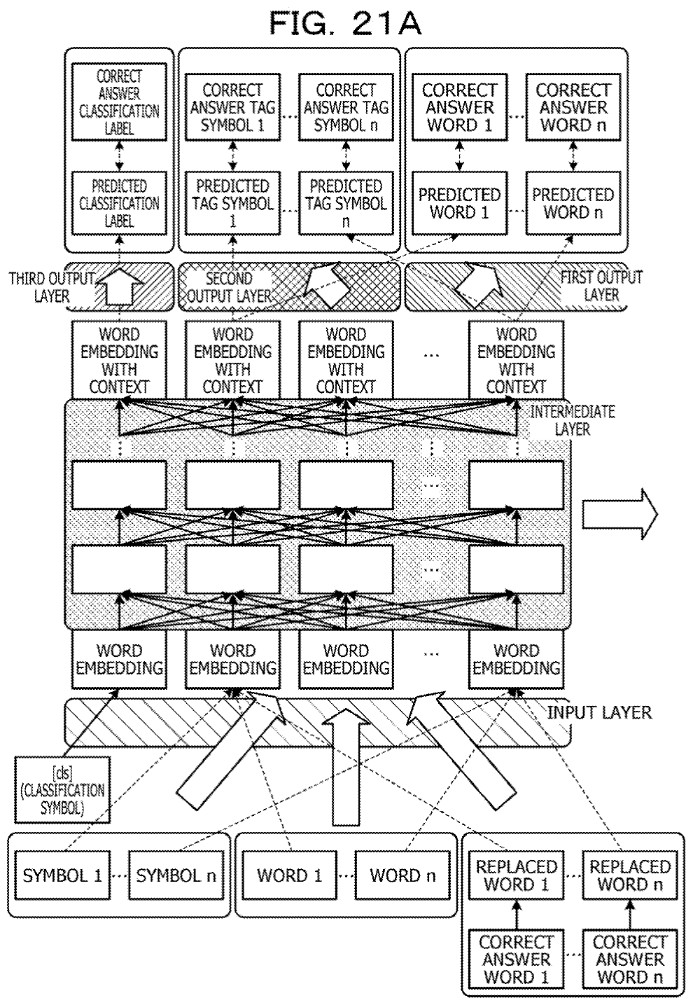

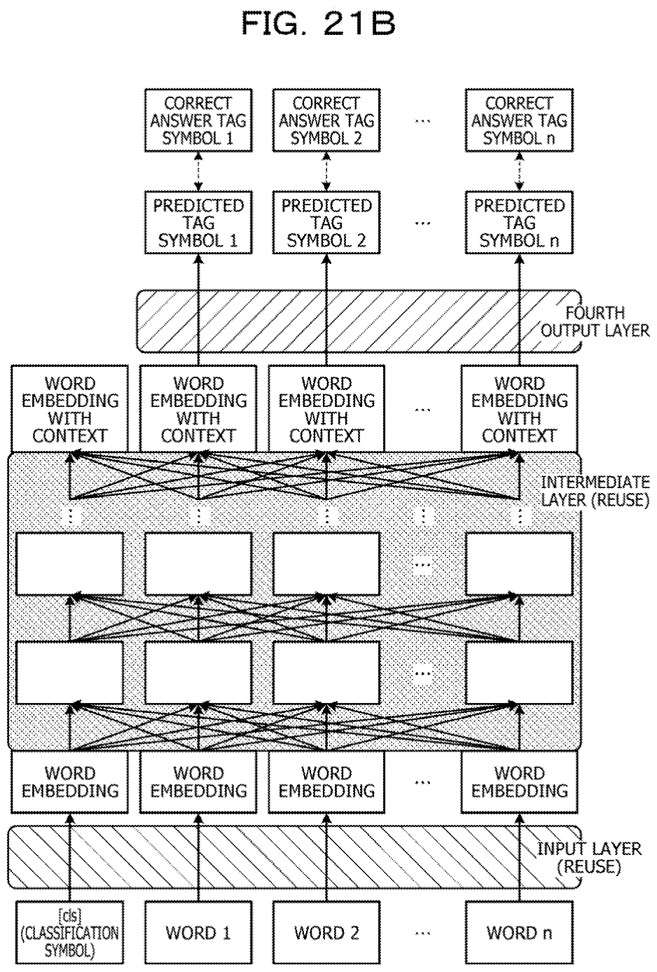

FIG. 21A and FIG. 21B are diagrams for describing an example of a neural network of adaptive training according to the third embodiment. FIG. 21A is the multi-task learning model described in the second embodiment. When training of the multi-task learning model illustrated in FIG. 21A and FIG. 21B ends, the adaptive training unit 50 incorporates a fourth output layer that predicts a chemical BIO tag instead of the first to third output layers of the trained multi-task learning model, as illustrated in FIG. 21B. For example, the adaptive training unit 50 reuses the trained input layer and intermediate layer to construct a chemical named entity extraction model, and executes training of the chemical named entity extraction model.

For example, the adaptive training unit 50 acquires text data including a chemical named entity tag, and acquires text data and a correct answer BIO tag for each paragraph from the named entity tagged data. Then, the adaptive training unit 50 generates a paragraph text which is text data without the chemical named entity tag, and also generates a correct answer BIO tag which serves as correct answer information (label) of supervised training. Thereafter, the adaptive training unit 50 inputs the paragraph text which is the text data without the chemical named entity tag into the chemical named entity extraction model, and executes tagging prediction by the chemical named entity extraction model. Then, the adaptive training unit 50 acquires a result of the tagging prediction from the fourth output layer, compares a result of restoration prediction with the correct answer BIO tag, and trains the chemical named entity extraction model including the trained input layer and intermediate layer, and the fourth output layer.

According to the third embodiment, since the training device 10 trains a new training model by reusing the trained input layer and intermediate layer, a training time may be shortened as compared with the case of training from scratch. Furthermore, the training device 10 may execute training including contextual knowledge trained by the pre-trained model, and may improve training accuracy as compared with the case of training from scratch. Note that, in the third embodiment, an example of adapting the multi-task learning model including three training models has been described, but the embodiment is not limited to this example, and a multi-task learning model including two or more training models may adapted.

### Fourth Embodiment

Incidentally, while the embodiments have been described above, the embodiments may be carried out in a variety of different modes in addition to the embodiments described above.

### Learning Data and the Like

The data examples, tag examples, numerical value examples, display examples, and the like used in the embodiments described above are merely examples, and may be optionally changed. Furthermore, the number of multi-tasks and the types of tasks are also examples, and another task may be adopted. Furthermore, training may be performed more efficiently when multi-tasks related to the same or similar technical fields are combined. In the embodiments described above, an example in which the neural network is used as the training model has been described. However, the embodiments are not limited to this example, and another machine learning may also be adopted. Furthermore, application to a field other than the language processing is also possible.

### System

Pieces of information including a processing procedure, a control procedure, a specific name, various types of data, and parameters described above or illustrated in the drawings may be optionally changed unless otherwise specified.

Furthermore, each component of each device illustrated in the drawings is functionally conceptual and does not necessarily have to be physically configured as illustrated in the drawings. For example, specific forms of distribution and integration of each device are not limited to those illustrated in the drawings. For example, all or a part thereof may be configured by being functionally or physically distributed or integrated in optional units according to various types of loads, usage situations, or the like.

Moreover, all or an optional part of individual processing functions performed in each device may be implemented by a central processing unit (CPU) and a program analyzed and executed by the CPU, or may be implemented as hardware by wired logic.

### Hardware

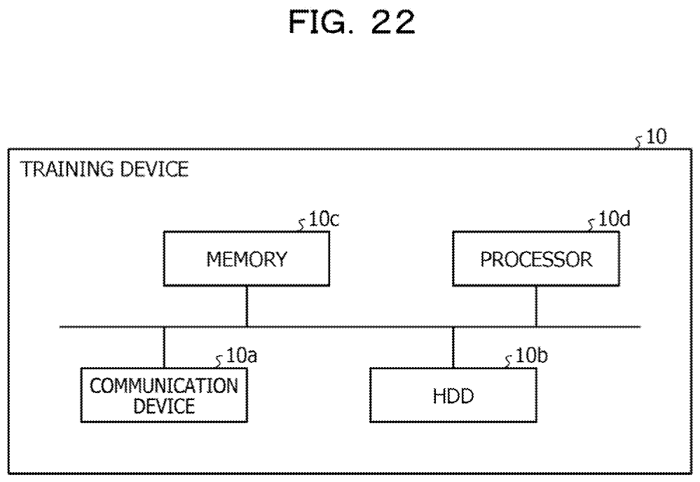

Next, an example of a hardware configuration of the training device 10 will be described. FIG. 22 is a diagram illustrating the example of the hardware configuration. As illustrated in FIG. 22, the training device 10 includes a communication device 10a, a hard disk drive (HDD) 10b, a memory 10c, and a processor 10d. Furthermore, the respective parts illustrated in FIG. 22 are mutually connected by a bus or the like.

The communication device 10a is a network interface card or the like, and communicates with another server. The HDD 10b stores programs and DBs for operating the functions illustrated in FIG. 3.

The processor 10d reads a program that executes processing similar to that of each processing unit illustrated in FIG. 3 from the HDD 10b or the like to develop the read program in the memory 10c, thereby operating a process for executing each function described with reference to FIG. 3 or the like. For example, this process executes a function similar to that of each processing unit included in the training device 10. For example, the processor 10d reads a program having a function similar to that of the training unit 30, the prediction unit 40, or the like from the HDD 10b or the like. Then, the processor 10d executes a process that executes processing similar to that of the training unit 30, the prediction unit 40, or the like.

In this way, the training device 10 operates as an information processing device that executes the training method by reading and executing a program. Furthermore, the training device 10 may also implement functions similar to those of the embodiments described above by reading the program described above from a recording medium by a medium reading device and executing the read program described above. Note that a program referred to in another embodiment is not limited to being executed by the training device 10. For example, the embodiments may be similarly applied to a case where another computer or server executes the program, or a case where these cooperatively execute the program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A training method for a computer to execute a process comprising:
acquiring a model that includes an input layer and an intermediate layer, in which the intermediate layer is coupled to a first output layer and a second output layer;
training the first output layer, the intermediate layer, and the input layer based on an output result from the first output layer when first training data is input into the input layer; and
training the second output layer, the intermediate layer, and the input layer based on an output result from the second output layer when second training data is input into the input layer.

2. The training method according to claim 1, wherein the process further comprising:
switching an output destination from the intermediate layer to layer selected from the first output layer and the second output layer based on a type of training data used for training the model;
inputting the first training data that corresponds to a first type into the input layer; and
inputting the second training data that corresponds to a second type into the input layer.

3. The training method according to claim 1, wherein the process further comprising:
inputting first training data into the input layer in which some words replaced to add noise in text data;
acquiring a restoration result of the text data from the first output layer; and
training the first output layer, the intermediate layer, and the input layer so that an error between the text data and the restoration result is reduced.

4. The training method according to claim 3, wherein the process further comprising:
generating text data and correct answer information from the second training data to which a named entity tag is attached;
inputting the text data into the input layer;
acquiring a result of tagging prediction from the second output layer; and
training the second output layer, the intermediate layer, and the input layer by supervised training based on an error between the correct answer information and the result of the tagging prediction.

5. The training method according to claim 1, wherein
the model is a model in which the intermediate layer is coupled to each of the first output layer, the second output layer, and a third output layer, wherein
the process further comprising training the third output layer, the intermediate layer, and the input layer based on an output result from the third output layer when third training data is input into the input layer.

6. The training method according to claim 5, wherein the process further comprising:
from the third training data in which a relation extraction label that indicates a relation between elements and a relation tag that indicates a relation are set, acquiring text data with the relation tag and the relation extraction label;
inputting the text data with the relation tag into the input layer;
acquiring a prediction label from the third output layer; and
training the third output layer, the intermediate layer, and the input layer by supervised training based on an error between the relation extraction label and the prediction label.

7. A non-transitory computer-readable storage medium storing a training program that causes at least one computer to execute a process, the process comprising:
acquiring a model that includes an input layer and an intermediate layer, in which the intermediate layer is coupled to a first output layer and a second output layer;
training the first output layer, the intermediate layer, and the input layer based on an output result from the first output layer when first training data is input into the input layer; and
training the second output layer, the intermediate layer, and the input layer based on an output result from the second output layer when second training data is input into the input layer.

8. A training device comprising:
one or more memories; and
one or more processors coupled to the one or more memories and the one or more processors configured to:
acquire a model that includes an input layer and an intermediate layer, in which the intermediate layer is coupled to a first output layer and a second output layer,
train the first output layer, the intermediate layer, and the input layer based on an output result from the first output layer when first training data is input into the input layer, and
train the second output layer, the intermediate layer, and the input layer based on an output result from the second output layer when second training data is input into the input layer.
